(19) United States
(12) Patent Application Publication
(10) Pub. No.: US 2006/0186175 A1
(43) Pub. Date: Aug. 24, 2006

(54) Metal containers for solder paste

(76) Inventor: Lawrence C. Kay, Los Angeles, CA (US)

Correspondence Address: CHRISTIE, PARKER & HALE, LLP, PO BOX 7068, PASADENA, CA, 91109-7068, US

(21) Appl. No.: 11/355,724

(22) Filed: Feb. 15, 2006

Related U.S. Application Data
(60) Provisional application No. 60/654,409, filed on Feb. 18, 2005.

(51) Int. Cl. B23K 1/08

(52) U.S. Cl. 228/36

(57) ABSTRACT

A container for soldering adjuvant is made of a metal having a composition similar to the composition of a solder bath. Preferably, the container holds solder paste and the container is made of metal having a composition similar to the composition of the metal part of the paste in the container. Exemplary alloys from which the container is made include 2.5 to 5% silver, up to 2% copper and a balance of tin; and a lead-tin eutectic composition.

### CROSS-REFERENCE TO RELATED APPLICATION(S)

This application claims priority benefit of the filing date of U.S. Provisional Application 60/654,409, filed Feb. 18, 2005

### BACKGROUND

Solder paste is a mixture of solder powder (often in form of tiny balls) and flux, which is commonly placed on printed circuit boards or the like for soldering electronic components or the like to the board. Solder paste is printed on the board and components put in to place. When heated, the flux and solder melt and form a solder joint between the leads on the component and conductive pads on the PC board. Solder paste may also be used differently.

Presently, solder paste is purchased by users in plastic containers. These may be plastic jars or “syringes” which resemble a caulking gun or the like, with a plastic tube containing the solder paste, a nozzle and a plunger for discharging the solder paste. When these containers are emptied, there is almost always some of the solder paste left within the container. Solder paste may be present on the bottom and walls of a jar or left in the nozzle when all of the paste in the tube has been discharged. Sometimes a container is set aside before all of the solder paste has been used and it even occurs that entire containers of solder paste are sometimes discarded since outdated.

This is an expense for the user of the solder paste since “emptied” containers are considered hazardous waste, particularly when the solder is lead-tin solder. Even lead-free solder paste may be considered a hazardous waste in some places, since silver-containing alloys are an important type of lead-free solder. Such hazardous waste must be disposed of in licensed hazardous waste disposal sites or sent to a recycler which may salvage some solder or more likely trans-ship this refuse to a licensed hazardous waste disposal site.

This kind of problem can be avoided by practice of this invention.

### BRIEF SUMMARY OF THE INVENTION

A container for soldering adjuvant wherein the container is made of metal having a composition similar to the composition of a solder bath.

### DRAWINGS

FIG. 1 illustrates a syringe for solder paste.

FIG. 2 illustrates a jar for containing a soldering adjuvant.

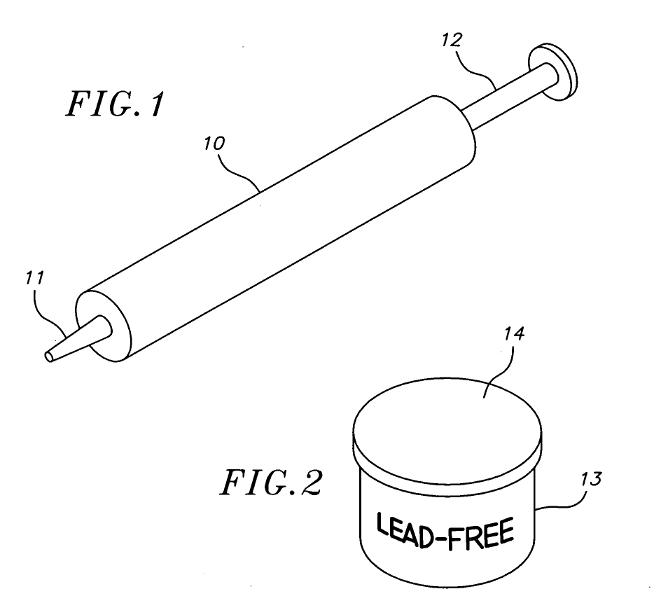

### DESCRIPTION

Solder paste is packaged in a metal container such as a syringe or jar as illustrated in the drawings. The syringe comprises a hollow tube 10 containing solder paste, with a nozzle 11 at one end for discharging the paste. A plunger 12 in the tube is pressed to discharge solder through the nozzle. Other types of containers such as jars 13, cans, squeeze tubes or more complicated syringe applicators may also be made of metal.

In practice of this invention, the container is preferably made of a solder alloy similar to the alloy in the solder paste contained within the container. The tube, nozzle and plunger of a syringe are preferably made of a similar alloy. Similarly, the jar and cover 14 for the jar of solder paste is made of an alloy similar to the solder in the paste in the jar. Thus, when solder paste is effectively exhausted or the container is otherwise ready for disposal it is simply put into a bath of molten solder of similar composition to the container and paste. The container and any remaining paste and flux melt into the bath. Flux (and solvent, if used) in the paste melts and in most cases “burns off” or vaporizes, and any charred or melted residue of flux is removed with the usual dross on a bath.

The solder paste may include dimer acid or the like mixed in the flux. Alternatively, the metal container may have a paste of solder powder and dimer acid without flux or with other additives. In such embodiments the dimer acid remaining in the used container remains on the surface of the solder bath after melting of the solder-like metal container. Such dimer acid on the solder bath serves to inhibit formation of dross and assimilates metal oxides that may form.

The container does not need to be a syringe as illustrated in the drawings, but may be a convenient size jar, bottle, can or a squeeze tube analogous to a toothpaste tube. Other possible containers will be apparent.

A similar bottle, jar, tube or the like may also be used for soldering adjuvants which do not contain metal powder (i.e. not a “solder paste”). For example, a bottle may contain dimer acid to add on the surface of a wave soldering apparatus. A bottle may have flux to use in hand or machine soldering. A bottle may have solvents or cleaning solutions used in association with soldering operations. There is often a clutter of emptied bottles, jars, tubes and the like in an electronics manufacturing facility, for example, which need to be disposed of via a hazardous waste facility. Similar accumulations of waste containers are generated in plants manufacturing storage batteries, automobile radiators, and other products where parts are soldered together. Many of these containers may also be made of an alloy similar to the alloy in one of the facility's solder baths.

It is not necessary that the container be made of exactly the same alloy as the solder paste or the solder bath in which it is to be melted, although that is preferable to minimize dilution or contamination of the solder bath in which the used containers are melted. For example, it may be desirable to make a squeeze tube of effectively pure tin for greater ductility than a solder alloy. In such a situation the cap for the tube can be made of an alloy composition that collectively with the tube has an average (or effective) composition similar to the composition in the bath in which the container is to be melted.

When the container is a jar or bottle with a screw top, for example, it may be appropriate to use different alloys for the jar and cover so that the average composition is similar to the composition of a solder bath. Likewise, a syringe and plunger may be made of different alloys with a suitable average composition. In such embodiments the different compositions help minimize galling between parts that move relative to each other. Galling can also be minimized by a thin layer of lubricant or other low friction material between the cover and jar, for example. Different alloys for the different parts may also be selected so that both parts have greater hardness or strength.

It is preferable, however, that the container and solder paste are made of a similar alloy. For example, when the solder paste is a eutectic 63% lead, 37% tin alloy it is desirable that the container also be a 63% lead, 37% tin alloy. A container of such an alloy can be made sufficiently thick to withstand the rigors of filling, shipping, using, etc., of the container and solder paste. Similarly, if the solder paste is lead-free, the container is made of similar lead-free alloy.

Thickness or weight different from an analogous plastic container is immaterial since the metal container is melted into a similar solder bath alloy composition and not wasted. Any added cost for the container is not an issue since an emptied container remains as raw material for the solder bath.

If the manufacturer using solder paste does not have comparable solder baths for other manufacturing operations, spent containers can simply be sent to someone else who employs a suitable bath. This may not be unusual since a manufacturer may prepare circuit boards, for example, which are pre-tinned using solder paste, and another manufacturer solders components on the boards with solder from a bath such as in wave soldering apparatus. The emptied metal containers could even be a source of revenue for the first manufacturer instead of an expense. No special requirements nor cost for disposal of hazardous waste would be involved.

It is preferred that the container, if not identical in average composition to the solder paste, at least have a composition including a principal portion similar to the principal element in the solder paste. This minimizes adjustments with other alloying elements that may be appropriate to avoid dilution of a solder bath. Thus, for example, a container for lead-free solder is made primarily of tin. A suitable weight of master alloy with other alloying elements may be added to the bath to minimize dilution.

A common lead-free solder is a tin-silver or tin-silver-copper alloy. Since the proportions of silver and particularly copper, are small in the solder paste the container may be essentially pure tin or have a near eutectic amount of silver without any copper. Thus, bath dilution is not a great concern since containers represent a relatively small fraction of the solder used from such a bath.

An exemplary preferred container is formed of an alloy having 3.5 to 5% silver and a balance of tin. Another preferred composition comprises 2.5-5% silver, up to 2% copper and a balance of tin. Exemplary alloys include Sn₉₆/Ag₄; Sn_{96.5}/Ag_{3.5}; Sn_{93.6}/Ag_{4.7}/Cu_{1.7}; Sn_{95.2}/Ag₄/Cu_{0.8}; Sn_{95.2}/Ag_{3.9}/Cu_{0.9}; Sn_{95.2}/Ag_{3.8}/Cu₁; Sn_{95.5}/Ag_{3.8}/Cu₁; Sn_{96.2}/Ag₃/Cu_{0.7}; Sn_{96.5}/Ag₃/Cu_{0.5}; Sn_{96.2}/Ag_{2.5}/Cu_{0.8}/Sb_{0.5}; and Sn_{99.3}/CuO₇. These are currently the most popular alloys and other lead-free alloys are known or may be developed. The preferred soldering alloys are the tin-silver-copper alloys.

Strengthening elements may be included in the alloy used to make a container if they are acceptable in a solder bath since the element could appear as a contaminant of the bath. Easily oxidized additives such as alkali metal or alkaline earth metal may be suitable since such materials may help scavenge oxides from the bath to be removed with dross.

Containers made of solder or solder-like alloys are made by injection molding in essentially the same type of equipment used for injection molding previously used plastic containers. Stamping, pressing or other casting processes may be used for various types of containers. It is desirable that the grade or composition of the metal used to make the container be stamped or molded into the container surface to assure that the container is disposed of in an appropriate solder bath.

What is claimed is:

1. A container for soldering adjuvant wherein the container is made of metal having a composition similar to the composition of a solder bath.

2. A container for soldering adjuvant according to claim 1 wherein the adjuvant comprises solder paste and the container is made of metal having a composition similar to the composition of the metal part of the paste in the container.

3. A container for soldering adjuvant according to claim 1 wherein the metal is primarily tin and is lead free.

4. A container for soldering adjuvant according to claim 1 wherein the metal alloy comprises 3.5 to 5% silver and a balance of tin.

5. A container for soldering adjuvant according to claim 1 wherein the metal alloy comprises 2.5 to 5% silver, up to 2% copper and a balance of tin.

6. A container for soldering adjuvant according to claim 1 wherein the metal is a tin-silver-copper alloy.

7. A container for soldering adjuvant according to claim 1 wherein the metal comprises 63% lead and 37% tin.

8. A container for solder paste wherein the container is made of metal having a composition similar to the composition of the metal part of the paste in the container.

9. A container for soldering paste according to claim 8 wherein the metal in the solder paste is primarily tin and is lead free, and the container comprises parts that collectively have a composition that is primarily tin and is lead free.

10. A container for soldering paste according to claim 8 wherein the metal in the solder paste is a tin-silver-copper alloy and the container comprises parts that collectively are a tin-silver-copper composition.

11. A container for soldering paste according to claim 8 wherein the metal in the solder paste comprises 3.5 to 5% silver and a balance of tin, and the container comprises parts that collectively have a composition that is 3.5 to 5% silver and a balance of tin.

12. A container for soldering paste according to claim 8 wherein the metal in the solder paste comprises 2.5 to 5% silver, up to 2% copper and a balance of tin, and the container comprises parts that collectively have a composition that is 2.5 to 5% silver, up to 2% copper and a balance of tin.

13. A container for soldering paste according to claim 8 wherein the metal in the solder paste comprises 63% lead and 37% tin, and the container comprises parts that collectively have a composition that is 63% lead and 37% tin.

14. A container made of metal having a composition similar to the composition of a solder bath.

15. A container according to claim 14 wherein the metal is primarily tin and is lead free.

16. A container according to claim 14 wherein the metal is a tin-silver-copper alloy.

17. A container according to claim 14 wherein the metal alloy comprises 3.5 to 5% silver and a balance of tin.

18. A container according to claim 14 wherein the metal alloy comprises 2.5 to 5% silver, up to 2% copper and a balance of tin.

19. A container according to claim 14 wherein the metal comprises 63% lead and 37% tin.
